(19) United States
(12) Patent Application Publication
(10) Pub. No.: US 2026/0034659 A1
(43) Pub. Date: Feb. 5, 2026

(54) ROTATING TOOL HOLDER

(71) Applicant: Stanley Puffer, Delevan, NY (US)

(72) Inventor: Stanley Puffer, Delevan, NY (US)

(21) Appl. No.: 18/788,616

(22) Filed: Jul. 30, 2024

(51) Int. Cl. B25H 3/00

(52) U.S. Cl. CPC B25H 3/00

(57) ABSTRACT

The present invention generally comprises a rotating tool holder apparatus for removably attaching a tool to a boom arm. The rotating tool holder apparatus includes a cylindrical base fixedly attached to the boom arm and a cylindrical outer shell rotatably connected around the cylindrical base. The invention also includes a tool holder bracket for removably attaching a tool to the cylindrical outer shell and a counterweight mounted to the cylindrical outer shell.

### BACKGROUND OF THE DISCLOSURE

Conventional boom mechanisms, like aerial lifts and knuckle boom loaders have tool holder mechanisms that are fixedly attached to an arm of a boom used to removably attach a tool such as a tree trimming and cutting tools close to an operator bucket. As a result of this fixed position, conventional holders position the tool out of reach of an operator as boom arms rotate and flip, creating inconvenience and unnecessary danger for workers, especially around power lines.

These booms are mounted on trucks and raise operators vertically for tree trimming and utility pole work. The jobs typically involve using long, bulky tools like saws designed for hard-to-reach areas. To prevent tools from falling, boom arms are equipped with tool holders mounted to the operator's bucket.

Conventional booms are typically designed with an upper and lower boom arm, and the operator can rotate the upper boom more than 180 degrees from a folded position, with the ability to rotate the boom arm over the center of a truck and to the ground at the rear of the truck thus flipping the position of the tool holder mechanism and tool in a downward position relative to the operator. The basket of a typical boom arm has an auto leveling kit so that as the operator rotates the bucket from the non-flipped over working position to the flipped over working position, the operator's bucket stays level with the ground thus keeping the operator in the bucket and not dumping operator out as the boom rotates.

The lower boom can be rotated 360 degrees around the truck while staying parallel to the ground. This flipped over position is often used to allow the operator to reach a flipped over position 180 degrees opposite the non-flipped over position.

Currently, the only option available are tool holder mechanisms fixed to one side of the boom arm. Fixed tool holders are not rotational and provide a great deal of inconvenience to operators as the boom arm flips. Due to their fixed position on the boom arm, conventional tool holders can only be used when working in the non-flipped-over position. These fixed holders only allow operators to stow the tool effectively and safely in one operating position, not both. Additionally, when using conventional fixed holders, the operator must remove the tool from the holder just before flipping the boom over to work in the flipped-over position. During the work in that position, the tool remains separate from the holder until the operator flips back. At that point, the holder is once again in front of the operator and ready to stow the tool.

When moving the bucket while holding the tool, the only options for the operator to hold the tool are either to grasp it with one hand or place it in the basket alongside the operator. Unfortunately, this approach raises safety and efficiency concerns and makes operation less convenient. Holding the saw with one hand limits the operator's ability to perform tasks that require two hands. Attempting to manage two-handed work with just one free hand can lead to an unsafe environment, potentially causing injuries or power disruptions due to reduced control and focus.

Additionally, if an operator tries to balance the tool on the bucket edge, it may extend several feet beyond the bucket. During bucket maneuvers, operators might forget about the extra clearance needed to avoid obstacles. The tool could be accidentally dropped while working or operating the boom, posing risks to nearby individuals, including other employees, pedestrians, and utility lines. If a serrated tool like a saw is placed in the bucket, its sharp teeth could come into close contact with legs and feet, leading to torn clothing or injuries.

Amidst the various hazards of boom work and maneuvering, it's easy to overlook how far a tool might extend. When operators hold a tool, they may inadvertently collide with other objects as the bucket is maneuvered around tree branches, power lines, utility poles, transformers, and similar obstacles. This collision can cause the tool to slip from their grasp and potentially strike and damage anything below.

Some bucket trucks, require the operator to use two hands while using some of the boom functions to maneuver. Regardless of the truck type, if you were to flip the boom all the way over without removing the tool beforehand, it tends to fall out of the stationary holder and strike whatever lies below—whether it's the ground, another piece of equipment, or even a person. Another method is where the operator removes the tool from the stationary holder, resting it on the basket's lip, and attempting to control it with one hand while operating the controls with the other hand to maneuver around obstacles. Operators often struggle to hold onto the tool while flipping the boom, positioning themselves for work, and avoiding other job hazards. Balancing the tool with one hand while performing tasks that ideally require both hands can lead to accidental drops.

Another conventional method for controlling the tool while maneuvering the boom arm is to place it vertically inside the basket alongside the operator. However, this approach can be dangerous and awkward. When using this method, the tool extends above the operator's head. As the boom maneuvers around tight spaces, such as tree branches or power lines, to access work areas, it's easy to underestimate the additional height clearance needed to move safely. Unfortunately, accidents occur: the tool can collide with the bucket, other equipment, or even the operator. These collisions cause injuries to the operator and the equipment.

Thus, there is a need for a rotating tool holder apparatus for removably attaching a tool to a boom, which addresses the aforesaid problems.

### SUMMARY

The present invention generally comprises a rotating tool holder apparatus for removably attaching a tool to a boom arm. The rotating tool holder apparatus includes a cylindrical base fixedly attached to the boom arm and a cylindrical shell rotatably connected around the cylindrical base. The invention also includes a tool holder bracket for removably attaching a tool to the cylindrical shell and a counterweight mounted to the cylindrical shell.

A general object of the present disclosure is to provide a rotating tool holder apparatus with a counterweight that acts as a counterbalance and positions the tool holder at a convenient and safe position for an operator.

Still another aspect of the disclosure includes a cylindrical base is made of a set of two semicircular sheets of 1/4 inch thick resilient material positioned around the boom.

Another object of the of the disclosure is to provide that the semicircular sheets of the cylindrical base are joined with alternating tabs and pins respectively at the ends of each sheet.

Another aspect of the disclosure includes a rotating tool holder apparatus for removably attaching a tool to a boom arm having cylindrical base with an outer surface having a plurality of grooved channels.

Another aspect of the disclosure may include that the cylindrical shell of the boom case assembly is made of about ½ inch of a thick resilient nonconductive material.

Still a further object of the present disclosure provides for a cylindrical shell of the boom case assembly with plurality of holes molded into the underside of the cylindrical shell with bearings in the holes that partially protrude out from the surface of the underside.

Still another object of the present disclosure provides for a cylindrical shell of the boom case assembly with the bearings that line up with the bearing groove channels on the outer surface of a cylindrical base.

Still another object of the present disclosure provides for a rotating tool holder apparatus for removably attaching a tool to a boom arm with a cylindrical shell of the boom case assembly having a smooth inner surface without grooves.

Still another object of the present disclosure provides for a cylindrical shell of the boom case assembly having a smooth inner surface without grooves.

Another aspect of the disclosure of a rotating tool holder apparatus for removably attaching a tool to a boom arm that provides a hollow counterweight pocket with a filling hole pre-molded on the lower part of the cylindrical base.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The accompanying drawings illustrate various embodiments of systems, methods, and other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a perspective view of a rotating tool holder apparatus mounted on a boom and rotated relative to the position of a bucket and boom, as depicted by broken lines in accordance with the present disclosure;

FIG. 2 is a perspective view of a rotating tool holder apparatus mounted on a boom and rotated relative to an alternant position of a bucket and boom, as depicted by broken lines in accordance with the present disclosure;

FIG. 3 is an exploded view of a rotating tool holder apparatus in accordance with the present disclosure;

FIG. 4 is a front perspective view of a cylindrical base in accordance with the present disclosure;

FIG. 5 is a rear perspective view of a cylindrical base in accordance with the present disclosure;

FIG. 6 is an exploded view of a cylindrical base in accordance with the present disclosure;

FIG. 7 is a front perspective view of a cylindrical shell in accordance with the present disclosure;

FIG. 8 is a rear perspective view of a cylindrical shell in accordance with the present disclosure;

FIG. 9 is an exploded view of a cylindrical shell in accordance with the present disclosure;

FIG. 10 is a side view of a rotating tool holder apparatus shown in FIG. 1 in accordance with one embodiment of the present disclosure;

FIG. 10A is a taken generally along line 10A-10A in FIG. 10 in accordance with one embodiment of the present disclosure;

FIG. 11 is a side view of a rotating tool holder apparatus shown in FIG. 1 in accordance with one embodiment of the present disclosure;

FIG. 11A is a taken generally along line 11A-11A in FIG. 11 in accordance with one embodiment of the present disclosure;

FIG. 12 is an exploded view of a rotating tool holder apparatus in accordance with another embodiment of the present disclosure; and

FIG. 13 illustrates in broken lines multiple possible orientations of the boom arm to depict how the rotating tool holder apparatus rotates so that the tool holder bracket remains positioned relative to the bucket.

### DETAILED DESCRIPTION OF THE DRAWINGS

While the making and using of various embodiments of the present disclosure are discussed in detail below, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatus and methods described herein. Such equivalents are considered to be within the scope of this disclosure and are covered by the claims.

In the drawings, not all reference numbers are included in each drawing, for the sake of clarity. In addition, positional terms such as “upper,” “lower,” “side,” “top,” “bottom,” etc. refer to the depicted system, apparatus, etc. when in the orientation shown in the drawing. A person of skill in the art will recognize that the system, apparatus, etc. can assume different orientations when in use. The term “a” means “at least one” and is not necessarily restricted to referring to a single object.

Currently it is known in the art that conventional boom arm mechanisms, like aerial lifts and knuckle boom loaders have tool holder mechanisms that are fixedly attached to the boom arm and are used to removably attach a tool such as a tree trimming and cutting tools close to an operator bucket. As a result of this fixed position, conventional holders position the tool out of reach of an operator as boom arms rotate and flip, creating inconvenience and unnecessary danger for workers, especially around power lines.

In contrast, the rotating tool holder apparatus of the present disclosure is designed to securely tools and automatically adjust the position of the tool as the boom is flipped. This autorotation ensures that the tool is always in the optimal position for the operator which reduces the need for manual adjustments, saving time and effort.

Furthermore, the rotating tool holder securely holds the tool and automatically adjusts its position, minimizing the risk of accidents and injuries. Operators can concentrate on controlling the boom and performing their tasks without concerns about the tool's stability.

The present invention generally comprises a rotating tool holder apparatus 100 for removably attaching a tool 104 to a boom 102. The rotating tool holder apparatus includes a cylindrical base 20 fixedly attached to the boom 102 and a cylindrical shell 30 rotatably connected around the cylindrical base. The invention also includes at least one tool holder bracket 50 for removably attaching the tool 104 to the cylindrical shell 30 and a counterweight 34 mounted to the cylindrical shell 30.

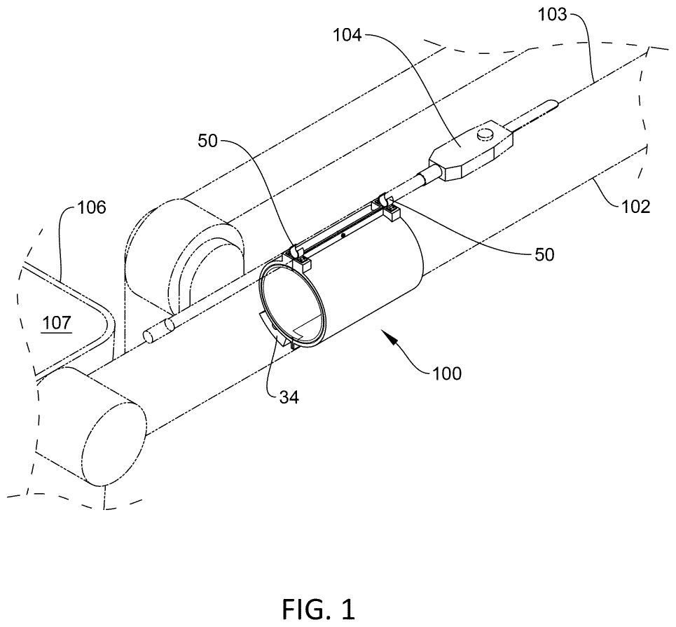

Adverting now to the drawings, with reference to FIG. 1, a preferred embodiment of the of present disclosure, is a perspective view of a rotating tool holder apparatus 100 mounted on a boom 102 and rotated relative to the position of a bucket 106 and boom 102 (depicted by broken lines). The rotating tool holder apparatus 100 allows the operator to rotate the upper boom from a folded position and automatically adjust the position of the tool as the boom is flipped.

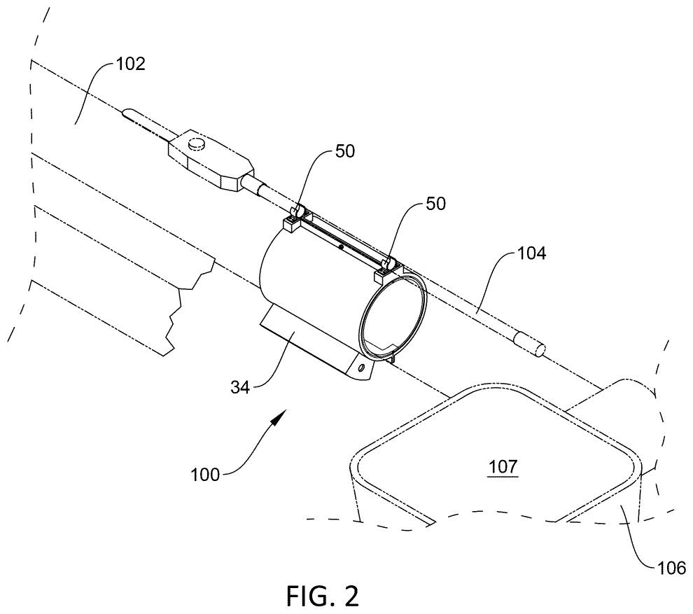

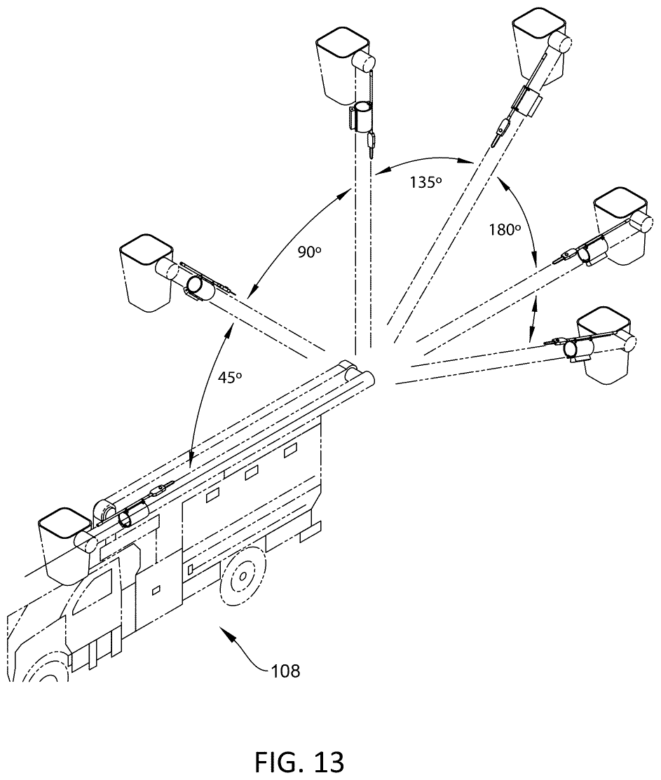

FIG. 2 is a perspective view of a rotating tool holder apparatus 100 mounted on a boom 102 rotated relative to an alternant position of a bucket 106 having a bucket opening 107 and boom 102, as depicted in FIG. 1. In this orientation of the boom 102, counterweight 34 acts as a counterbalance and tool holder and tool counter rotate so that the tool 104 which is removably attached to tool holder brackets 50, is positioned close to the bucket opening 107 of the bucket 106. Bucket 106 is commonly known as an aerial device or cherry picker. Typically, a boom truck 108 (shown in FIG. 13) has an extendable and articulating boom with a bucket or platform at the end. The bucket allows personnel to be raised to elevated work areas, providing safe and controlled access for tasks at various working heights.

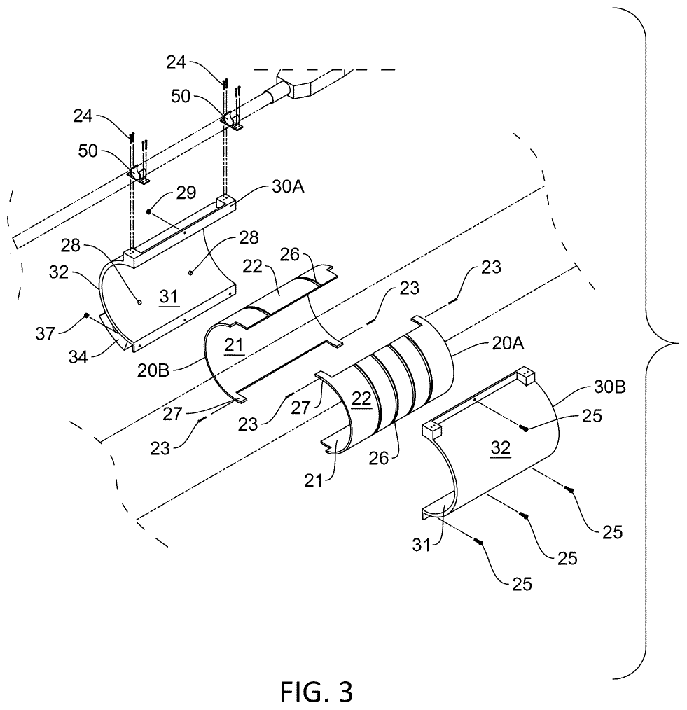

FIG. 3 is an exploded view of a rotating tool holder apparatus 100 in accordance with the present disclosure. The rotating tool holder apparatus includes a cylindrical base 20 and a cylindrical shell 30. Cylindrical base 20 and a cylindrical shell 30 are preferably semicircular pieces of ¼ inch thick resilient plastic or the like. Cylindrical base 20 is comprised of a first cylindrical base semi-section 20A and a second cylindrical base semi-section 20B. Cylindrical base 20 has a base concave inner surface 21 and a base convex outer surface 22. Cylindrical shell 30 is comprised of first cylindrical shell semi-section 30A and second cylindrical shell semi-section 30B. Cylindrical shell 30 has a shell concave inner surface 31 and a shell convex outer surface 32.

The first cylindrical base semi-section 20A and the second cylindrical base semi-section 20B are joined, after being positioned on a boom, using pins 23 to secure alternating mating tabs 27. Cylindrical base 20 fixedly connects around the boom 102. In this embodiment the boom has a boom convex outer surface 103 that marries with base concave inner surface 21 of cylindrical base 20. However, it should be understood by one skilled in the art, that booms may have other shapes and thus the inner concave surface of the cylindrical base could be modified to marry and fixedly connect with different shaped boom arms.

Similarly, first cylindrical shell semi-section 30A and second cylindrical shell semi-section 30B are joined together, after being positioned around cylindrical base 20 using nut 29 and bolts 25. And it should be understood by those skilled in the art that other connecting means can be employed such as molding, gluing, soldering and the like.

Cylindrical base 20 is further comprised of a plurality of channels 26 molded into base convex outer surface 22. Cylindrical shell 30 further comprises a plurality of bearings 28 molded into shell concave inner surface 31, where bearings 28 partially protrude from the surface and line up with the channels 26 of base convex outer surface 22. The base concave inner surface 21 has a substantially equal radius to the radius of the boom convex outer surface 103 to form a common axis and wherein the shell concave inner surface 31 is concentrically receivable therein with cylindrical base to form second axis rotatable around first axis.

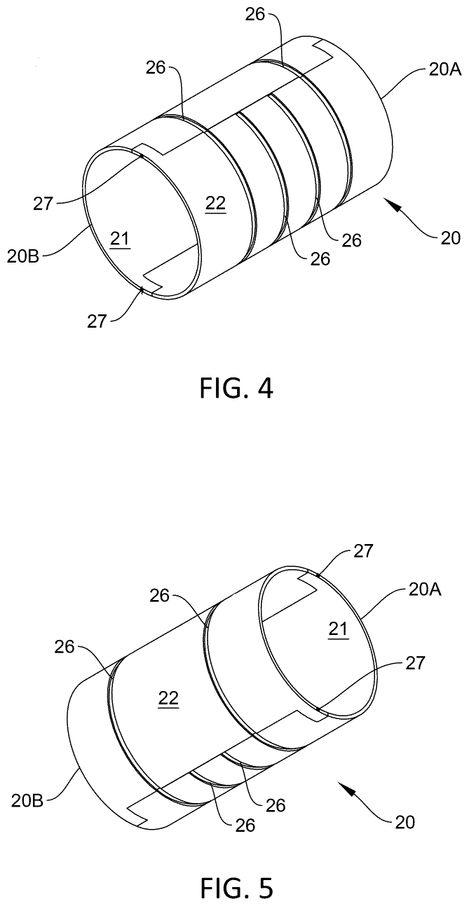

FIG. 4 is a front perspective view of a cylindrical base 20 showing base convex outer surface 22 in accordance with the present disclosure. In this embodiment the first cylindrical base semi-section 20A features four equidistantly spaced parallel channels 26, while the second cylindrical base semi-section 20B includes two parallel channels 26. The channels on the second cylindrical base semi-section 20B align with the outer channels on the first cylindrical base semi-section 20A, creating two circumferential channels that encircle the entire base convex outer surface 22 and two inner channels that encircle half of the base convex outer surface 22 of the cylindrical base 20.

FIG. 5 shows a rear perspective view of the cylindrical base 20, again highlighting the base convex outer surface 22. During rotation, when the bearings 28 that engage with the inner channels 26 of the first cylindrical base semi-section 20A reach the end of these channels and encounter the second cylindrical base semi-section 20B, rotation is halted. This mechanism restricts the rotation of the rotating tool holder apparatus 100, preventing entanglement with boom control cables and limiting rotation to 180 degrees along the common axis.

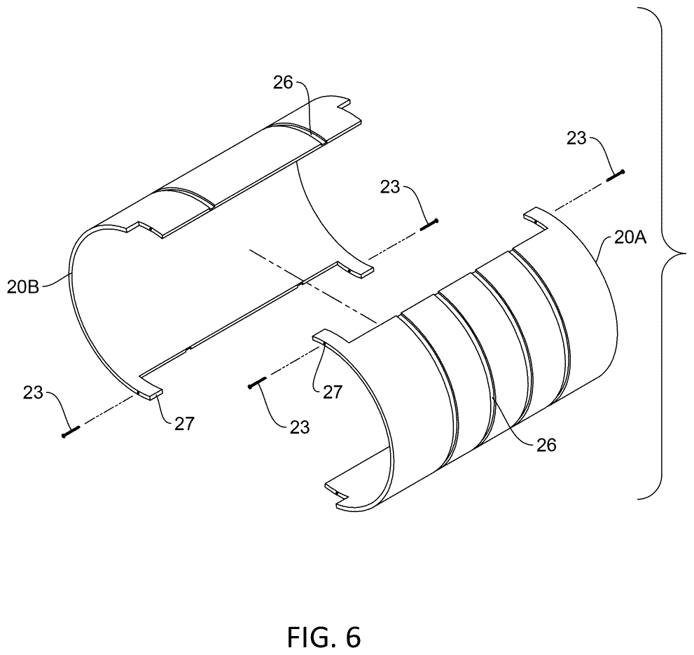

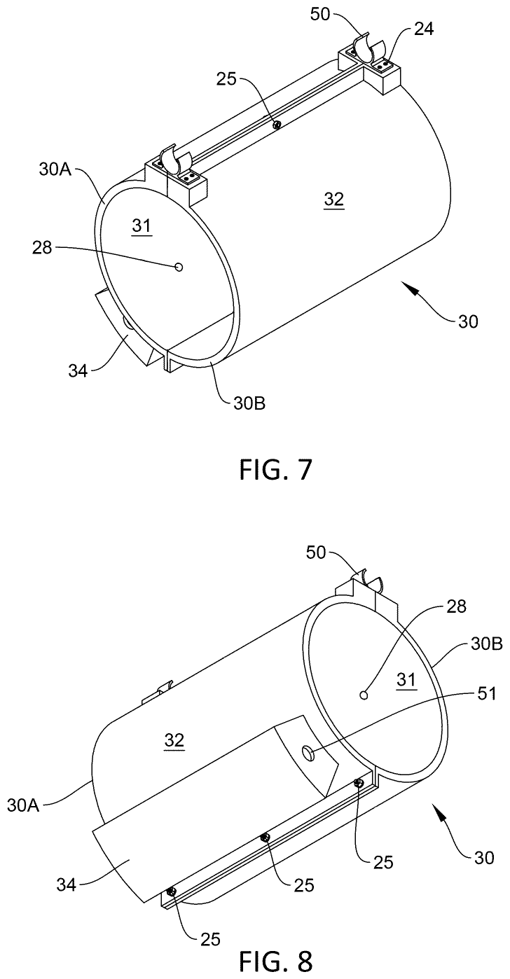

FIG. 6 is an exploded view of a cylindrical base 20 in accordance with the present disclosure. The first cylindrical base semi-section 20A and the second cylindrical base semi-section 20B are joined, after being positioned on a boom, using pins 23 to secure alternating mating tabs 27. FIG. 7 is a front perspective view of a cylindrical shell 30 in accordance with the present disclosure. FIG. 8 is a rear perspective view of a cylindrical shell 30 in accordance with the present disclosure showing counterweight 34 with filling hole 51. Cylindrical shell 30 is comprised of first cylindrical shell semi-section 30A and second cylindrical shell semi-section 30B. Cylindrical shell 30 has a shell concave inner surface 31 and a shell convex outer surface 32. A counterweight 34 is carried by the first cylindrical shell semi-section 30A and rotatable therewith for counterbalancing the tool holder brackets 50 and tool 104 in extended locations. The counterweight is a hollow pocket that is molded to the first cylindrical shell semi-section 30A. The hollow counterweight pocket is filled through the filling hole 51 by removing plug 37 with an amount of material having sufficient weight to counter balance the tool. The preferred type of material to act as a counter weight is a nonconductive material such as silicon, sand, and wood saw, although any material can be used to fill the counterweight 34.

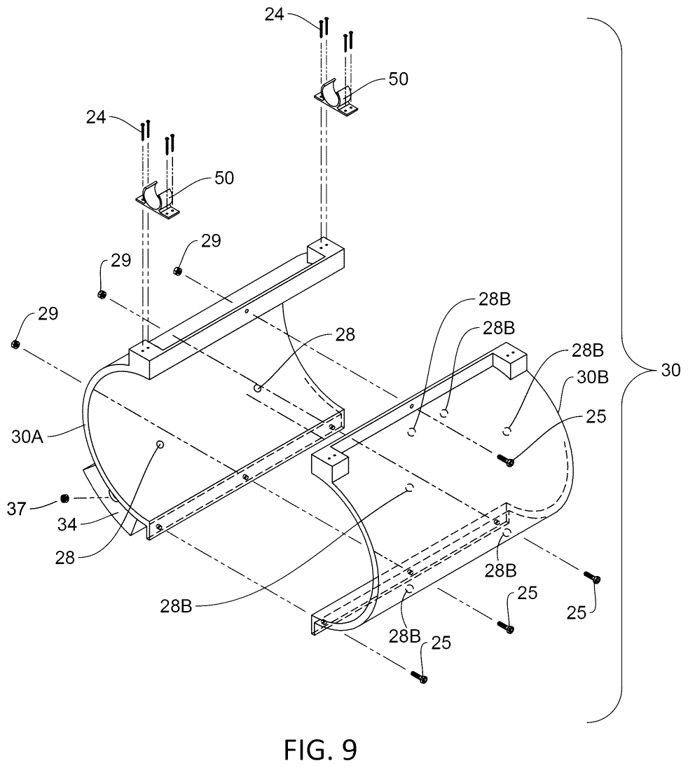

FIG. 9 is an exploded view of a cylindrical shell 30 in accordance with the present disclosure. FIG. 9 shows how first cylindrical shell semi-section 30A and second cylindrical shell semi-section 30B are arranged prior to being joined together, before being positioned around cylindrical base 20, using nut 29 and bolts 25. And it should be understood by those skilled in the art that other connecting means can be employed such as molding, gluing, soldering and the like.

Additionally, FIG. 9 shows that the bearings 28 are spaced approximately equally around the inner surface of the cylindrical shell 30 at intervals of 45 degrees, 135 degrees, 225 degrees, and 315 degrees. These bearings ride in the two outer bearing channels 26 that encircle the base convex outer surface 22 of the base, ensuring the unit remains balanced both when stationary and during rotation.

In this embodiment, there are a series of bearings 28 molded to the concave inner surface of the first cylindrical shell semi-section 30A and the second cylindrical shell semi-section 30B. The relative interior positions of the bearings 28 are denoted by broken line circles 28B on the outer surface of the second cylindrical shell semi-section 30B. Each inner surface of the first cylindrical shell semi-section 30A and second cylindrical shell semi-section 30B contain bearings 28 aligned to fit into the channels 26 of the cylindrical base 20. Second cylindrical shell semi-section 30B contains six bearings 28 and first cylindrical shell semi-section 30A contains four bearings 28, all of which are aligned to mate with channels 26 of cylindrical base 20.

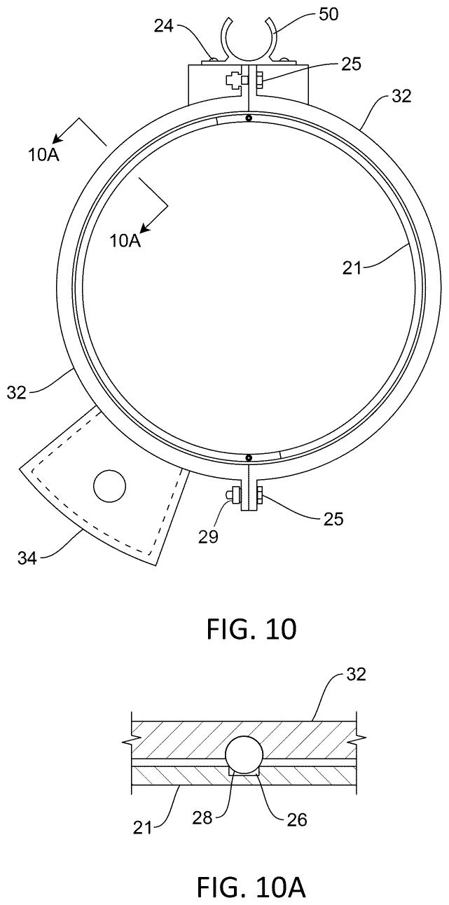

FIG. 10 is a side view of a rotating tool holder apparatus shown in FIG. 1 in accordance with one embodiment of the present disclosure. FIG. 10 illustrates that first cylindrical base semi-section 20A and second cylindrical base semi-section 20B are opposingly placed together to form the cylindrical base 20. Further, first cylindrical shell semi-section 30A and second cylindrical shell semi-section 30B are rotatably connected to cylindrical base 20 to form cylindrical shell 30. Additionally, tool holder brackets 50 are secured using screws 24 and positioned at the top of cylindrical shell 30. The first cylindrical shell semi-section 30A and second cylindrical shell semi-section 30B are joined together with nut 29 and bolts 25. Furthermore, FIG. 10 shows a counterweight 34 secured to the shell convex outer surface 32 of the cylindrical shell.

FIG. 10A is a sectional view a taken generally along line 10A-10A in FIG. 10 in accordance with one embodiment of the present disclosure. Particularly, FIG. 10A illustrates how the first cylindrical shell semi-section 30A and second cylindrical shell semi-section 30B are placed over the cylindrical base 20 and how channel 26 accepts the bearing 28.

Slots engaged with bearings provide several benefits, including lateral stability by restricting lateral movement. This ensures precise alignment between components and keeps the bearing secure even under load or vibration. The limited circumferential length of the slots (limited length channels are shown in FIGS. 4 and 5) limits rotational movement, preventing a full 360-degree rotation that could entangle control wires.

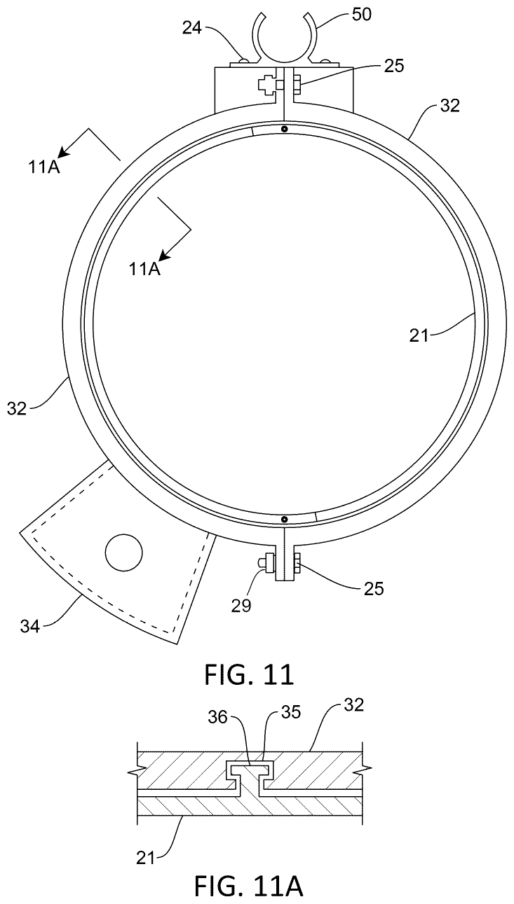

FIG. 11 is a side view of a rotating tool holder apparatus shown in FIG. 1 in accordance with one embodiment of the present disclosure. FIG. 11A is a taken generally along line 11A-11A in FIG. 11 in accordance with one embodiment of the present disclosure. While the embodiments shown throughout the figures include a channel and bearing arrangement, other rotation management methods, such as the tongue and groove system depicted in FIG. 11A, can also be used. Specifically, FIG. 11A demonstrates how the first cylindrical shell semi-section 30A and second cylindrical shell semi-section 30B are positioned over the cylindrical base 20 and how T-shaped channel 35 accommodates the T-shaped tongue 36.

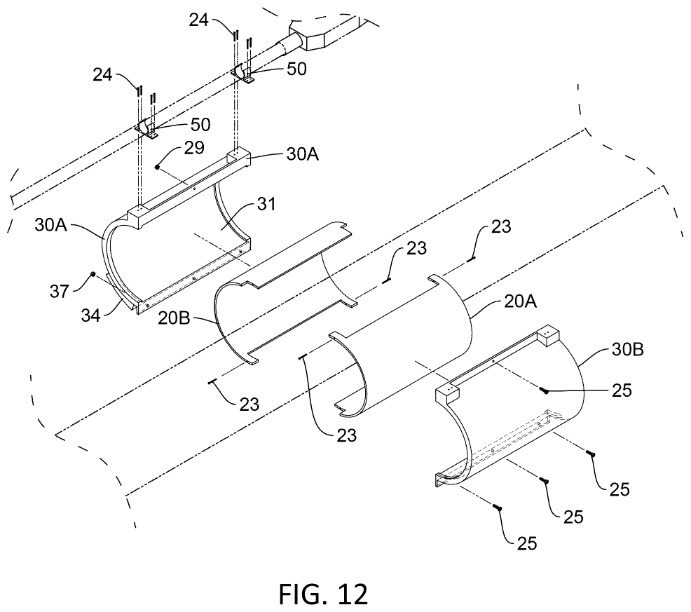

FIG. 12 is an exploded view of the rotating tool holder apparatus 100 in accordance with another embodiment of the present disclosure. It should be understood by those skilled in the art that the rotating tool holder apparatus 100 can be made without channels and bearings or the like. The rotating tool holder depicted in FIG. 12 comprises a cylindrical base 20 and a cylindrical shell 30. Cylindrical base 20 in this embodiment is made without channels 26 molded into base convex outer surface 22. Cylindrical shell 30 has a smooth shell concave inner surface 31 without any channels. This embodiment allows for a complete 360° rotation of cylindrical shell 30. The base concave inner surface 21 has a substantially equal radius to the radius of the boom convex outer surface 103 to form a common axis and wherein the shell concave inner surface 31 is concentrically receivable therein with cylindrical base to form second axis rotatable around first axis.

Cylindrical base 20 is comprised of first cylindrical base semi-section 20A and second cylindrical base semi-section 20B and a cylindrical shell 30 is comprised of first cylindrical shell semi-section 30A and second cylindrical shell semi-section 30B. The base and the shell is preferably semicircular pieces of ¼ inch to ½ inch thick resilient nonconductive material such as plastic or the like. Cylindrical base 20 has a base concave inner surface 21 and a base convex outer surface 22. Further, the cylindrical shell 30 has a shell concave inner surface 31 and a shell convex outer surface 32.

The first cylindrical base semi-section 20A and second cylindrical base semi-section 20B are joined, over a boom 102, with pins 23 to secure alternating mating tabs 27. Cylindrical base 20 fixedly connects around the boom 102. In this embodiment the boom has a boom convex outer surface 103 that marries with base concave inner surface 21 of cylindrical base 20. Similarly, first cylindrical shell semi-section 30A and second cylindrical shell semi-section 30B are joined together, after being positioned over the cylindrical base 20, using nut 29 and bolts 25. And it should be understood by those skilled in the art that other connecting means can be employed such as molding, gluing, soldering and the like.

FIG. 13 shows, in broken lines, various possible orientations of the boom arm to demonstrate how the rotating tool holder apparatus keeps the tool holder bracket aligned with the bucket. FIG. 13 depicts the boom arm at different positions with 45° intervals: 0°, 45°, and 90°. After 90°, the boom arm continues to rotate to positions at 135°, 180°, and an additional 20° beyond 180°. It is clear that, regardless of the boom's position, the tool holder remains accessible to the bucket operator. By maintaining the tool holder bracket in a consistent position relative to the bucket, the rotating tool holder apparatus for removably attaching a tool to a boom reduces the risk of accidental collisions or misalignments that could cause damage or injury. The rotating tool holder apparatus, which can rotate through various angles relative to boom truck 108 (for example 45°, 90°, 135°, 180°, and beyond), offers flexibility in positioning the tool. This flexibility makes it easier to access different parts of the work area without needing to keep the tool inside the bucket.

Thus, although there have been described particular embodiments of the present disclosure of a new and useful rotating tool holder apparatus, it is not intended that such references be construed as limitations upon the scope of this disclosure.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed:

1. A rotating tool holder apparatus for removably attaching a tool to a boom arm comprising:
a cylindrical base fixedly attached the boom arm;
a cylindrical shell rotatably connected around the cylindrical base;
a tool holder bracket for removably attaching a tool to the cylindrical shell; and
a counterweight mounted to the cylindrical shell.

2. The rotating tool holder apparatus as claimed in claim 1, wherein the boom arm has a first end attached to a boom truck and a second end attached to an operator bucket and wherein the tool holder bracket is positioned opposite the counterweight to maintain the tool holder bracket in an upward position relative to the operator bucket.

3. The rotating tool holder as claimed in claim 1, wherein the ratio thickness of the cylindrical base and the cylindrical outer shell ranges from 1:2-1:4.

4. The rotating tool holder as claimed in claim 1, wherein the cylindrical base is comprised of a first cylindrical base semi-section and a second cylindrical base semi-section.

5. The rotating tool holder as claimed in claim 4, wherein the cylindrical base semi-sections, each having a base concave inner surface and a base convex outer surface.

6. The rotating tool holder as claimed in claim 5, wherein the cylindrical shell comprises a first cylindrical shell semi-section and a second cylindrical shell semi-section, joined together after being positioned around the cylindrical base with screws and bolts.

7. The rotating tool holder as claimed in claim 6, wherein the cylindrical shell semi-sections, each having a shell concave inner surface and a shell convex outer surface.

8. The rotating tool holder as claimed in claim 7, wherein the first cylindrical base semi-section and the second cylindrical base semi-section are joined with alternating mating tabs and pins.

9. The rotating tool holder as claimed in claim 8, wherein the cylindrical base has a plurality of channels along the base convex outer surface.

10. The rotating tool holder as claimed in claim 9, wherein the cylindrical shell comprises plurality of bearings in the shell concave inner surface.

11. The rotating tool holder as claimed in claim 10, wherein the plurality of bearings in the shell concave inner surface line up with the plurality of channels on the cylindrical base.

12. The rotating tool holder as claimed in claim 1, wherein the counterweight is hollow and filled through filling hole with a nonconductive material.

13. The rotating tool holder as claimed in claim 11, wherein the boom arm has a boom convex outer surface marrying with the base concave inner surface that has a substantially equal radius to the radius of the boom convex outer surface to form a common axis.

14. The rotating tool holder as claimed in claim 13, wherein the base convex outer surface of the first cylindrical base semi-section comprises four channels and the second cylindrical base semi-section comprises two outer channels.

15. The rotating tool holder as claimed in claim 14, wherein the plurality of bearings are positioned in the inner surface of the cylindrical shell to engage with the four channels of the first cylindrical base semi-section and the two outer channels of the second cylindrical base semi-section.

16. A rotating tool holder apparatus for removably attaching a tool to a boom comprising:
a boom arm having a first end attached to a boom truck and a second end attached to an operator bucket;
a cylindrical base comprised of a first cylindrical base semi-section and a second cylindrical base semi-section having a base concave inner surface and a base convex outer surface fixedly attached to the boom arm;
a cylindrical shell having a shell concave inner surface and a shell convex outer surface, rotatably connected around the cylindrical base, the cylindrical shell comprised of a first cylindrical shell semi-section and a second cylindrical shell semi-section;
a tool holder bracket for removably attaching a tool to the shell convex outer surface; and
a counterweight mounted to the to the shell convex outer surface.

17. The rotating tool holder as claimed in claim 16 wherein the shell concave inner surface comprises plurality of T-shaped tongues which mate with a plurality of T-shaped channels in the base convex outer surface.

18. The rotating tool holder as claimed in claim 17, wherein the base convex outer surface of the first cylindrical base semi-section comprises four T-shaped channels and the second cylindrical base semi-section comprises two outer T-shaped channels.

19. The rotating tool holder as claimed in claim 16 wherein the shell concave inner surface comprises plurality of bearings which mate with a plurality of channels in the base convex outer surface.

20. The rotating tool holder as claimed in claim 19, wherein the base convex outer surface of the first cylindrical base semi-section comprises four channels and the base convex outer surface of the second cylindrical base semi-section comprises two outer channels.
